(19) United States
(12) Patent Application Publication
(10) Pub. No.: US 2004/0118258 A1
(43) Pub. Date: Jun. 24, 2004

(54) Method and device for rotary processing of materials

(76) Inventors: Thomas Dera, Geislingen (DE); Helmut Domes, Stuttgart (DE); Michael Freund, Adelberg (DE); Frank Grueneberg, Kuchen (DE); Andreas Schweizer, Bad Ditzenbach Gosbach (DE)

Correspondence Address: Kevin L. Leffel, Heidelberg Digital L.L.C., 2600 Manitou Road, Rochester, NY, 14624, US

(21) Appl. No.: 10/612,352

(22) Filed: Jul. 2, 2003

(30) Foreign Application Priority Data
Jul. 4, 2002 (DE) 102 30 051.8

(51) Int. Cl. B26D 3/00; B23D 63/12; B26D 1/12

(52) U.S. Cl. 83/39; 83/168; 83/663; 83/683; 83/917; 83/934; 76/37

(57) ABSTRACT

The invention is in the field of adhesive binding of sheet-form printed materials arranged in stacks and, in particular, is directed to a method and device of the type that cuts side edges of sheet-form printed materials with tool. According to various aspects of the invention, a tool having a cutting edge and a notching element is provided as well as a method of making the tool, and a method of changing a depth of notching by changing an angle of rotation relative to a cutting plane is described.

### BACKGROUND

The invention is in the field of adhesive binding of sheet-form printed materials arranged in stacks and, in particular, is directed to a method and device of the type that cuts side edges of the sheet-form printed materials with a single tool.

For books or brochures in small print runs, an adhesive binding is often used to bind the individual pages. In particular, adhesive binding is used for the finishing of digital printings and copies as a result of the particularly low print runs involved in that process, for example when only one copy is produced.

For the manufacture of an adhesive binding, the sheet-form printed materials that ultimately form the finished bound book or brochure are first collected and aligned together in a stack. This stack of sheet-form printed materials is clamped in such a way as to prevent the possibility of any individual sheet-form printed materials slipping within the stack. Next, one page from the stack of sheet-form printed materials is first planed and then brushed with an appropriate adhesive. As adhesives, different hot and cold glues, or so-called dispersion glues, are possible. The type of adhesive is, however, irrelevant to the invention at hand. If the side edges of the sheet-form printed materials are merely beveled before the adhesive is applied, then the adhesive as a rule has only a slight contact surface with the sheet-form printed materials that are to be fixed, because the adhesive can only bind with the straight side edges of the individual sheet-form printed materials. This leads to low tear-out resistance of the sheet-form printed materials in the finished bound product.

The quality of the adhesive binding can be improved by enlarging the surface of the side edge and thereby the contact surface between the adhesive and the sheet-form printed material.

Further improvement of the adhesive binding can be achieved by improving the wetting of the side edge of the sheet-form printed material with adhesive.

This can result, for example, from exposing the paper fibers of the side edge of the sheet-form printed material that ultimately ensure the mechanical anchoring of the sheet-form printed material in the adhesive. This is an important requirement in the case of coated paper in particular, because in that case as well only the fiber portion contributes to the cohesiveness, but the coat portion can constitute up to half of the material here. For that reason an additional notching tool or other roughing tool is used in many devices for processing the side edges of sheet-form printed materials in preparation for an adhesive binding in order to expose the paper fibers and improve the anchoring between paper and adhesive. However, in addition to the roughening of the side edges of the sheet-form printed materials in the stack, it is also necessary first to level the surface to be adhered, a result that is typically achieved in the first step with a planing tool. The step involving the beveling of the side of the stack that is to be adhered in the adhesive binding of kerfs is imperative, because this involves first cutting off the spine notches.

Such a device is disclosed, for example, in Swiss patent specification CH 30 36 78. In a first outer-lying ring, cutting tools are appropriate for the leveling of a spine, and notching tools are anticipated in an inner ring for the roughening of the spine. Thus, a directed book block is first leveled by the cutting tools and subsequently provided with arched, crossing notches on the spine by the notching tools.

A further generic device is disclosed in German patent specification DE 19 29 901 C3. In said device, a round cutting blade rotates on a drive shaft, whereby the cutting blade has teeth along its circumference in order to cut the spine edge of a paper stack that is guided over it. Additionally, one or more of the teeth pointing upwards on the cutting blade are fit in such a way that they can be positioned vertically. Thereby the cutting depth of the upwards-pointing teeth can be changed.

A further generic device that combines the leveling or roughening of book or brochure blocks before the application of adhesive in a tool head is disclosed in German patent publication DE 100 22 836 A1. Said device includes a rotation-driven tool head with outer tools arranged along its circumference for the processing of the block spine, such as planning or cutting, and with tools arranged within the outer-lying tools for the finishing of the block spine, such as notching and roughening. The device provides incremental height adjustments between the first and second tools to change the cutting depth of the second tools. Furthermore, in a particular model, brushes on the tool head are provided for removing the dust that results from the processing of the book block spine as well as lose paper particles.

A further device for inserting notches on the side edges of the sheet-form printed materials in the stack in preparation for the adhesive binding is revealed in British patent application GB 20 96 945 A. In this device, notch cutters are added to a rotating disc over which a stack of sheet-form printed materials is directed. The rotation axis of the tool head is lightly tilted with respect to the vertical for the direction of movement of the stack of sheet-form printed materials, so that the notch teeth come into contact with the stack of paper-shaped printing substrates on only one side of the tool head.

A further device for the roughening of a pressed-together book block spine formed from individual printed sheets is disclosed in European patent specification EP 799 718 B1. Here the machining plane of the roughing tool features a flat blade angle α with respect to the book block spine in such a way that the roughing tool creates markings in its movement through the segments that trail the direction of movement; the machining depth of said markings is different from the markings formed in the segments of the preceding direction of movement.

### BRIEF DESCRIPTION OF THE DRAWINGS

FIG. 1 a schematic illustration of the device in accordance with the invention;

FIG. 2 a schematic illustration of the device in accordance with one aspect of the invention having a tilted rotary axis;

FIG. 3. a schematic isometric illustration of the cutting elements and cutting plate of the device in accordance with the invention;

FIG. 4 a schematic top-view of the cutting elements and cutting plate of the device in accordance with the invention;

FIG. 5 a schematic enlargement of the cutting elements of the device in accordance with the invention in isometric illustration;

FIG. 6 a schematic enlargement of the cutting elements of the device in accordance with the invention in side view.

### DESCRIPTION

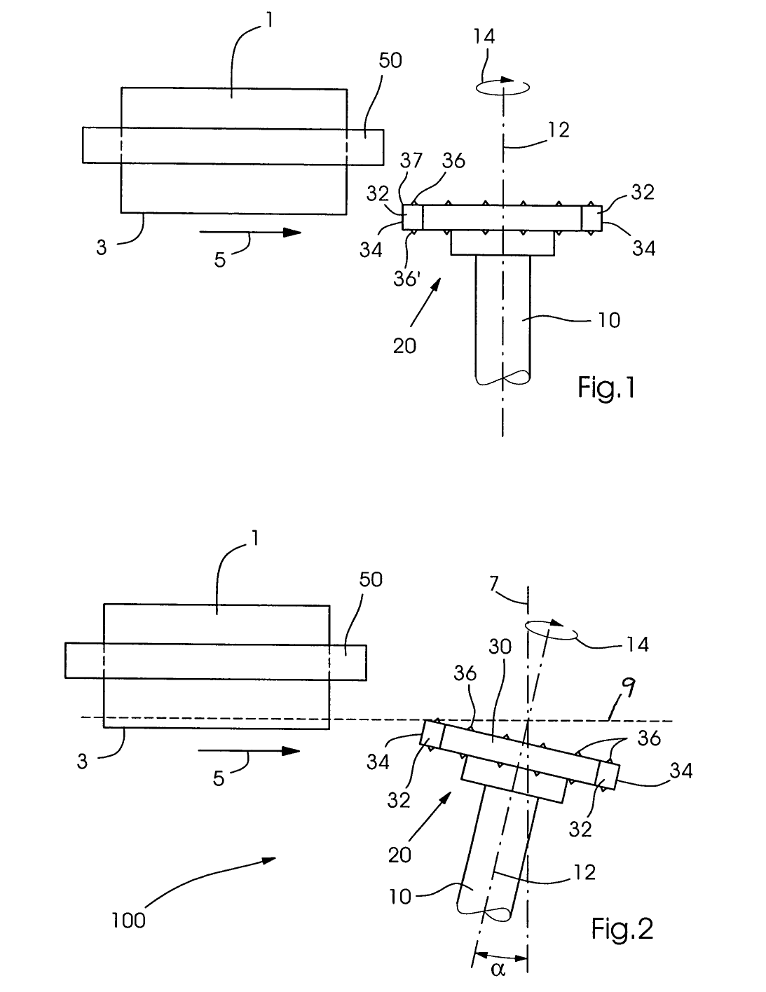

Various aspects of the invention are presented with reference to FIGS. 1-6, which are not drawn to any particular scale, and wherein like components in the numerous views are numbered alike. Referring now specifically to FIGS. 1 and 2, a method and device 100 according an aspect of the invention is presented. Material 1 involves a stack of sheet-form printed materials 1 in the demonstrated embodiments. A stack of sheet-form printed materials 1 having a shared side edge 3 is transported toward tool 20 along a direction of movement labeled with the reference symbol 5. The stack of sheet-form printed materials 1 is prevented from fanning by nipper 50. Nipper 50 also helps ensure that the sheet-form printed materials 1 do not slip in the stack from the resulting shear stress. Tool 20 is located with cutting elements 32 in the direction of movement of the sheet-form printed materials 1. Tool 20 rotates around rotary axis 12, with the rotary axis 12 forming an angle α to the vertical 7 on cutting plane 9, as shown in FIG. 2. Rotary axis 12 and vertical 7 lie over another in FIG. 1. Cutting elements 32 come into contact with side edge 3 of the sheet-form printed materials 1 on cutting plane 9, and thereby bevel the sheet-form printed materials 1 up to cutting plane 9.

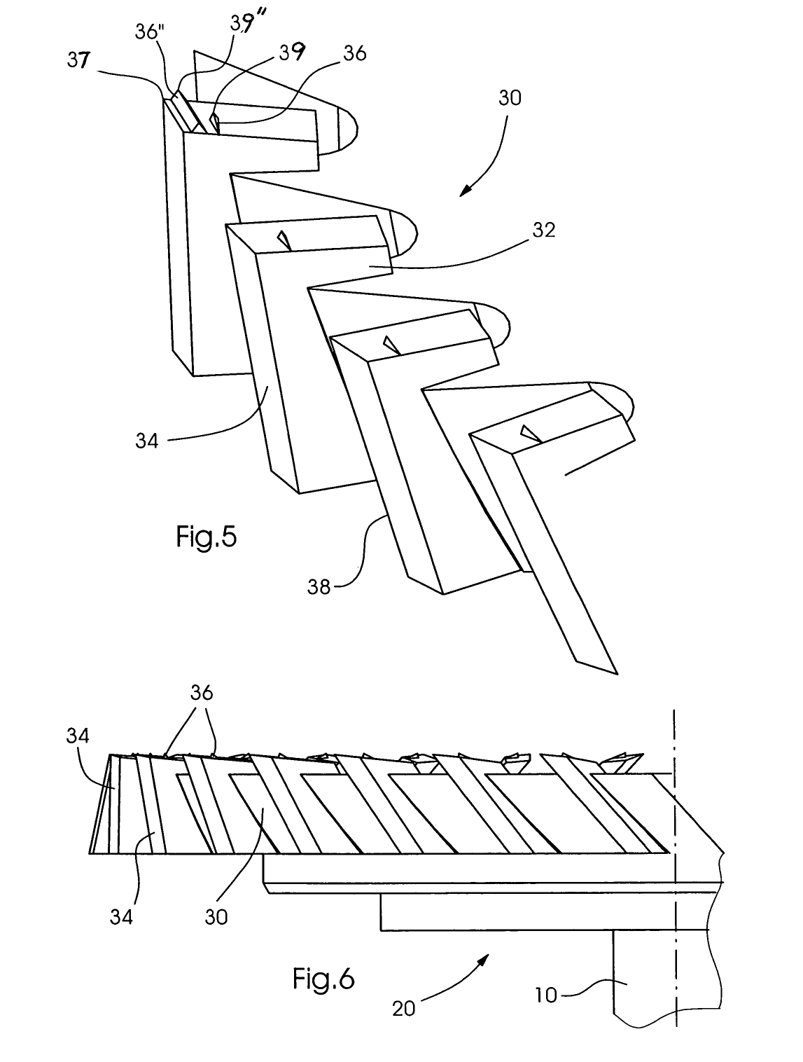

Referring now to FIGS. 2 and 5, if tool 20 is positioned at angle α to vertical 7 on cutting plane 9, the leading upper corner 37 of cutting edge 34 of the respective cutting elements 32 comes into contact with the stack of sheet-form printed materials 1. Notching segments 36 feature a geometry here as well, so that upper corner 39 of notching segment 36 projects over cutting plane 9 and the roughening of the sheet-form printed materials 1 is achieved. From a geometric perspective, it is clear that a variation in the roughening depth can be achieved with a change in angle at a predetermined processing geometry.

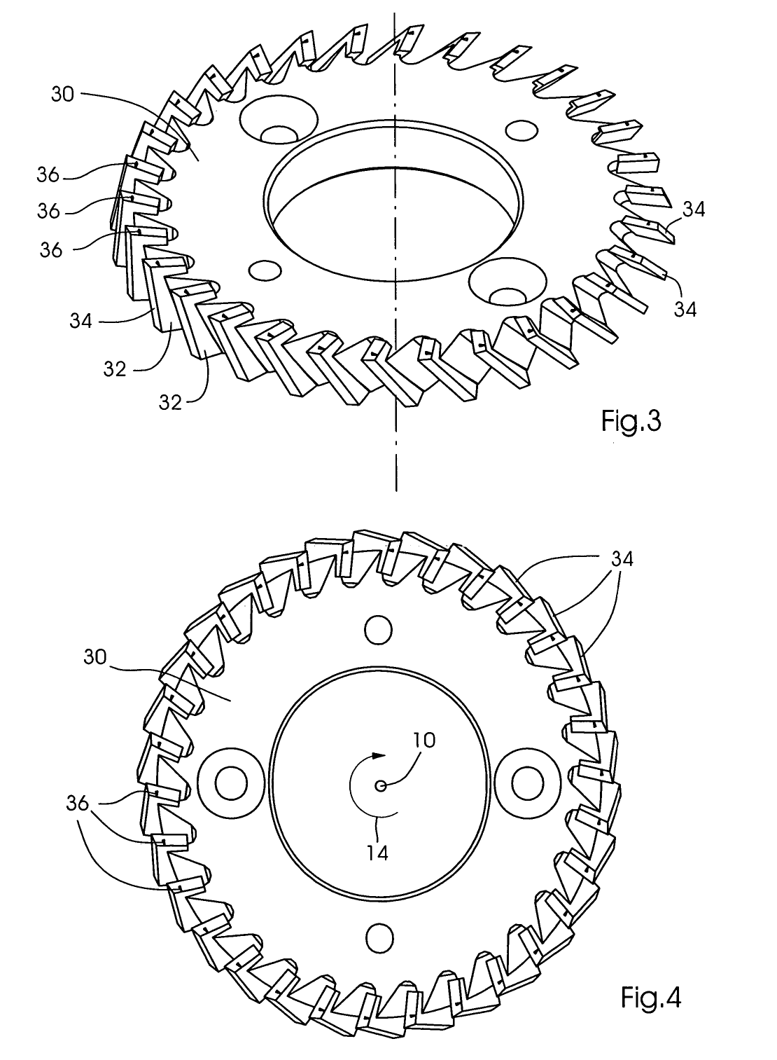

Tool 20 rotates during processing of the stack of sheet-form printed materials 1 around the rotary axis that is designated with reference symbol 12 in the shown figures in a direction that is designated in the figures with an arrow that has reference symbol 14. As can be seen in FIG. 3 in particular, tool body 30 (a ring, for example) features a number of cutting elements 32 along its circumference. Cutting elements 32 are attached to tool body 30 and tilted forward in rotational direction 14. Cutting elements 32 feature cutting edges 34 that cause the cut through the sheet-form printed materials 1. Cutting edges 34 serve as the leading outer edges of cutting elements 32 in direction of movement 14. The cut through the sheet-form printed materials 1 essentially occurs on upper corner 37 (FIG. 1), which represents the upper end of cutting edges 34. Cutting edge 34 features a typical undercut. On the one hand, cutting elements 32 can be detachably mounted on tool body 30, for example by screwing, and alternatively cutting elements 32 can also be permanently attached to tool body 30, for example through soldering.

Furthermore, cutting elements 32 feature small notching segments 36 on the side facing the sheet-form printed materials; in particular, compare especially FIG. 5 and FIG. 6. The notching segments 36 may be disposed inside the cutting edges 34 (radially inward for example). In a first model, notching segments 36 are wedge-like structures with an upper corner 39, which, in connection with upper corner 37 of cutting edges 34, determines the roughening depth. Alternatively, prism-type notching segments 36″ with upper corners 39″ can be foreseen in a second model. The latter model 36″, 39″ has the advantage that this geometry can be ground easier from cutting elements 32, and in addition offers greater stability compared to the first model 36, 39. Of course, other variations are possible.

FIG. 5 shows only a single cutting element 32 with a notching segment 36″ for the clarification of the geometry of the second embodiment. Cutting elements 32 advantageously feature either notching segments 36 of the first embodiment or notching segments 36″ of the second embodiment.

Cutting elements 32 are, for example, diamond-cut hard metal dies. Another embodiment has ground steel dies that are subsequently hardened, for example through ion implantation. The latter embodiment has the advantage that the grinding tool suffers less wear in the production of cutting edges 34, and in particular notching segments 36. This makes the production of cutting elements 32 more cost-effective.

As shown in FIG. 3 and FIG. 4, notching segments 36 are essentially arranged in a circle. That is not required, though. In an alternate embodiment (not shown), notching segments 36 can be arranged in a radial direction in order to achieve alternate notching patterns on the beveled side of materials 1. Another option is to provide two or more notching rings 40 on tool 20, which, for example, would also have a lesser number of notching elements 36 per cutting element 32.

The roughening depth of notching segment 36 or upper corner 39 of notching segment 36 results from the height staggering between upper corner 39 and notching segments 36 and upper corner 37 and cutting edges 34.

The device in accordance with the invention 100 is useful in particular for small adhesive bindings or other devices in preparing side edges of sheet-form printed materials 1 before a side edge gluing, but in principle it can also be used for processing other surfaces. Accordingly, the device in accordance with one aspect of the invention relates to a device for the processing of materials that are moved along a particular direction of movement in a cutting plane with a tool that is driven around a rotary axis and has a tool body, with several cutting elements being lined up along the circumference of the cutting tool, with the cutting elements having at least one cutting edge for cutting the material, with the cutting edge having at least one cutting edge facing the material that defines the cutting plane, and with at least one of the processing materials facing the material in its axial direction having at least one notching segment that projects over the cutting edge in the cutting plane.

With the configuration of notching and cutting elements on the cutting element, action can be taken on the roughening depth of the notching element very conveniently. In the event that the material constitutes a stack of sheet-form printed materials, the roughening depth that determines the penetration of the notching elements over the cutting edge is an essential factor that affects the characteristics of the finished adhesive binding. In this context a low roughening depth leads to the result that the adhesive applied to the processed side edges of the sheet-form printed materials arranged in the stack can penetrate only slightly from the side into the stack of sheet-form printed materials. A low penetration depth of the adhesive is typically linked with low tear-out resistance of the sheet-form printed materials from the stack but also with advantageous impact performance of the bound stack of sheet-form printed materials. In contrast, a large roughening depth and therefore a higher penetration of the adhesive in the side of the stack of sheet-form printed materials typically results, conversely, in high tear-out resistance of the sheet-form printed materials from the stack, but poor impact performance of the bound stack. In order to achieve good impact performance of the bound stack of sheet-form printed materials and high tear-out resistance, it is therefore necessary to adjust the roughening depth to the optimal setting. That optimal roughening depth can be different for various types of sheet-form printed materials depending on the quality of the sheet-form printed materials, the paper weight, the material, etc. By arranging the notching segments and cutting edges on the same cutting element, this predetermined roughening depth can be achieved easily and optimally with precision up to one hundredth of a millimeter. An adjustment of two individual processing stations to each other or of individual notching elements and cutting elements that are arranged, for example, on different rings, can be achieved technically with this level of precision only with extremely great effort, if at all.

A further advantage arises from the arrangement of the notching segments and cutting edges on the same cutting element with the only marginally necessary space, whereby compact adhesive binders can be achieved with advantageous performance characteristics.

A further advantage of arranging the notching segments and cutting edges on the same cutting element arises from the large radius that the notching segments have compared to a device in which the cutting elements are arranged in an outer ring, and the notching elements are arranged on an inner ring on the tool. Additionally, with this larger radius, the speed is also increased with which the notching segments in the beveled side of the stack of sheet-form printed materials travel through the larger radius. With the greater speed of the backside re-intake of the notching segments, improved cleaning of dust and other impurities from the material surface can be achieved. Additionally, with greater speed, a larger radius of the cutting angle of the notching segment is improved, because with a growing radius, the notching segment acts on the material edge with an increasing entrance angle, ideally with a right entrance angle. Thereby it can be avoided that the notching segment tears through the material, but rather cuts through said material instead.

In accordance with one aspect of the invention, each cutting element provides exactly one notching segment; alternately, a cutting element can also provide a plurality of notching segments, arranged in particular along the radius of the upper side of the cutting element. Another alternate embodiment involves the notching segments of the individual cutting elements being staggered along the radius. Thereby, alternate notching patterns can be created on the beveled side of the material.

In accordance with one aspect of the invention, the notching segment is ground out of the cutting element. This technique certainly offers the easiest option for creating notching segments on the cutting element. Alternately, special bits can also be created, which can be attached to the cutting elements that already have a cutting edge. By grinding the cutting elements typically meant to be used only as cutting elements, it is possible to create the desired identical geometry of all individual cutting elements on the tool body at very low tolerances. Cutting elements that serve merely to cut or bevel are sufficiently known from prior art.

The material of the cutting elements advantageously involves sintered hard metal. Alternately, cutting elements can be used that are made out of steel that is later hardened through ion implantation. This has the advantage that the steel can then be ground more easily, which results in less wear on the grinding tool, thereby lowering the manufacturing costs. Diamond cutters are typically used as a grinding tool. Additionally, the surface of the final processing geometry is hardened through subsequent ion implantation.

In accordance with another advantageous embodiment, the cutting elements are soldered onto the tool body. This simplifies the final assembly of the tool and all of the cutting elements can be easily exchanged. Complicated assembly of individual cutting elements with each other on the tool body can be dispensed with as soon as the cutting elements have been soldered on. Alternately, non-detachable connection methods for the joining of two metal pieces can also be used in accordance with the invention.

In accordance another advantageous embodiment, the cutting elements are first soldered onto the tool body during the manufacturing of the cutting elements, and then the cutting edges and notching segments are ground out of the cutting elements. Although the exchange of individual cutting elements on the tool body is thereby made more difficult, on the other hand no additional assembly of individual cutting elements is necessary. In particular, this eliminates all assembly tolerances among the individual cutting elements. The advantage of having an identical processing geometry of the individual cutting elements in this way down to a hundredth of a millimeter outweighs said disadvantage.

In accordance an especially advantageous embodiment, the notching segment is reground when worn, with the cutting level of the cutting edge being ground down. In particular, the height of the cutting edge is lowered so that the original height difference between the uppermost edge of the cutting edge and the uppermost edge of the notching segment are reached again. Because said regrinding can be performed again for all cutting elements simultaneously, and because these cutting elements do not suffer losses in their spatial relation to one another, perfect coordination between cutting edges and notching segments of all the cutting elements of the tool can be achieved even after a regrinding. If steel is selected as the material for the cutting elements, and the steel has been hardened using ion implantation after the grinding of the notching segments, there is the additional advantage that a further hardening can be undertaken after the grinding to renew the processing geometry by means of ion implantation.

After the regrinding, the tool body can be lined in order to reach the old cutting plane again without any changes having to be made to the rest of the device. The washer can be specially fitted to the worn cutting level of the cutting elements. Alternately, prefabricated washers can be used with a predetermined thickness, and accordingly the regrinding cuts down the cutting elements by the predetermined thickness of the prefabricated washers.

In accordance another advantageous embodiment, the rotary axis of the tool is tilted in such a way relative to the side edge of the materials to be processed that the rotary axis forms a sharp angle α to the vertical of the direction of movement. Thereby only one side of the cutting edges ends up in contact with the side edges of the sheet-form printed materials. Thus, the cutting force arising during processing can be reduced, which leads to a greater performance of the cutting tool. Through the reduction in cutting force, the expansion of the stack of sheet-form printed materials can be avoided during processing. A further advantage arises from the gradient of the rotary axis, which compensates unavoidable manufacturing and assembly tolerances that lead to a swaying motion of the tool through a sufficiently large choice of angle α.

In an advantageous embodiment, the angle α is set in such a way that the notching segments dip twice into the cutting plane of the materials; the cutting edges in contrast only once. On the one hand this causes the notching segments to notch the side edges of the materials in two different roughening depths. Because the notching segments apply to the side of the materials in a smaller roughening depth during the second application, smaller cutting forces result there.

In the event that the materials to be processed involve a stack of sheet-form printed material, the smaller cutting forces lead to an advantageous dust removal on the cutting plane, if the stack of sheet-form printed materials is slightly fanned in that area. A thorough dust removal of the processed side edge of the sheet-form printed material is important, because paper and dust particles that otherwise appear on the surface to be processed interfere with the wetting of the side edges by adhesives.

In an advantageous embodiment, the angle α is adjustable, and in particular, the angle α can be adjusted to the consistency of the materials. This is an advantage in particular for adjusting the processing of the materials to the properties of the materials (for example if the material involves a stack of sheet-form printed materials), the quantity of sheet-form printed materials in the stack, the type of sheet-form printed materials, if and how the sheet-form printed materials are printed, in particular in the area of the side edge to be processed, etc. For example, the continually variable adjustability of the notching depth can be achieved with a continually variable adjustability of angle α. Alternately, a step-like adjustability of the angle α is also conceivable.

In another advantageous embodiment, a cleaning brush is integrated into the tool. The cleaning brush is attached to the surface of the tool in the area that lies within the adjustment for the cutting elements and serves to improve the dust removal of the processed surfaces of the stack of sheet-form printed materials.

In another advantageous embodiment, the rotation of the tool is directed at creating a vacuum in the area of the tool, which suctions off the material particles generated during processing. This can be achieved, for example, if an exhaust spiral is provided in the center of the planing disc. With the rotation of the cutting disc, said exhaust spiral, which principally functions similar to a hairdryer, generates an air flow away from the surface of the sheet-form printed materials to be processed. Thereby an advantageous vacuuming can be achieved directly at the point of origin of the material particles. In the event that the materials involve a stack of sheet-form printed materials, dust removal is again facilitated, and the quality of the adhesive binding is thereby improved by improving the moistening of the side edges of the sheet-form printed materials with the adhesive.

In another advantageous embodiment, at least one of the cutting elements also features at least one notching element on the side of the tool body that faces away from the material. This is an advantage especially when a second preferred notching depth can be achieved by integrating the tool body that faces away into the tool. In this way the notching depth can be easily adjusted between two preferred notching depths.

What is claimed is:

1. A device for cutting side edges of sheet-form material for binding, comprising:
a tool body;
at least one cutting element fixed to the tool body, the at least one cutting element defining at least one cutting edge and at least one notching segment.

2. The device of claim 1, wherein the notching segment is ground out of the cutting element.

3. The device of claim 1, wherein the cutting edge is soldered to the tool body.

4. The device of claim 1, comprising a plurality of the at least one cutting edges arranged along a circumference of the tool body and fixed thereto.

5. The device of claim 1, comprising a cleaning brush integrated into the tool body.

6. The device of claim 1, further comprising at least one additional notching element on a side of the cutting element opposite the at least one notching element.

7. A method of cutting side edges of sheet-form material for binding, comprising:
rotating a tool about an axis of rotation at an angle to a cutting plane, the tool having at least one cutting edge and least one notching segment inside the cutting edge and projecting over the cutting plane; and,
cutting the sheet-form material with the at least one cutting edge along the cutting plane and notching the sheet-form material with the notching segment.

8. The method of claim 7, wherein the notching segment extends a distance into the sheet-form material, and further comprising changing the distance by changing the angle.

9. The method of claim 7, wherein the at least one notching segment notches the sheet-form material twice each pass, and the at least one cutting edge cuts the sheet-form material once each pass.

10. The method of claim 7, comprising a plurality of cutting edges arranged along a circumference of the tool, and a plurality of notching segments inside the cutting edges.

11. The method of claim 7, further comprising creating a vacuum by the rotation of the tool.

12. A method of making a device for cutting side edges of sheet-form material for binding, comprising:
forming a cutting edge and a notching element into at least one cutting element; and,
fixing the at least one cutting element to a tool body.

13. The method of claim 12, comprising:
forming the cutting edge and the notching element into the at least one cutting element; and,
subsequently fixing the at least one cutting element to the tool body.

14. The method of claim 12, comprising:
fixing the at least one cutting element to the tool body; and,
subsequently forming the cutting edge and the notching element into the at least one cutting element.

15. The method of claim 12, comprising a plurality of the at least one cutting elements;
wherein the fixing comprises soldering the plurality of the at least one cutting elements onto the tool body; and,
subsequently grinding the cutting edge and notching segment of each of the at least one cutting elements.

16. The method of claim 12, comprising reforming the cutting edge and notching segment upon wear.

17. The method of claim 16, wherein the reforming comprises grinding with a cutting level of the cutting element being ground off.
